(19) United States
(12) Patent Application Publication
(10) Pub. No.: US 2025/0350347 A1
(43) Pub. Date: Nov. 13, 2025

(54) ENERGY EFFICIENT MODE FOR CONNECTING USER EQUIPMENT TO NON-TERRESTRIAL NETWORK

(71) Applicant: T-Mobile USA, Inc., Bellevue, WA (US)

(72) Inventors: Gaviphat Lekutai, Kirkland, WA (US); Chad C. Au, Kirkland, WA (US); Kun Lu, Bellevue, WA (US); Jun Liu, Sammamish, WA (US)

(21) Appl. No.: 18/660,173

(22) Filed: May 9, 2024

(51) Int. Cl. H04B 7/185; H04W 48/18; H04W 52/02; H04W 64/00

(52) U.S. Cl. CPC H04B 7/18513; H04W 48/18; H04W 52/0225; H04W 64/00

(57) ABSTRACT

Systems and methods are described herein for configuring a wireless device to conserve energy when scanning to connect to a non-terrestrial network (NTN). In some aspects, the system comprises instructions to activate an NTN mode that configures the wireless device to periodically scan for an NTN, estimate a geolocation of the wireless device based on Global Positioning System (GPS) coordinate data received by the wireless device, determine a physical obstruction to line-of-sight (LOS) from the wireless device to the NTN based on the geolocation of the wireless device and the map data, temporarily pause the wireless device from periodically scanning for the NTN in response to the determination of the physical obstruction to LOS from the wireless device to the NTN, and cause the wireless device to scan for an alternative network other than an NTN or cellular network while the wireless device is temporarily paused from periodically scanning for the NTN.

### BACKGROUND

Non-terrestrial networks (NTNs) are wireless communication systems that operate above the Earth's surface, involving satellites at low Earth orbit (LEO), medium Earth orbit (MEO) and geostationary orbit (GEO), high-altitude platforms (HAPS), and drones. Such components are essential to realizing seamless coverage, bringing coverage even to remote areas that do not have access to traditional terrestrial networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates components of a network connection environment in some implementations.

FIG. 3 is a flow diagram that illustrates a process to configure a wireless device in some implementations.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed herein are systems and related methods for managing power consumption of user equipment (UE) devices that are in an NTN mode but do not have an unobstructed line-of-sight (LOS) to connect to non-terrestrial networks (NTNs). The disclosed system evaluates the environment surrounding the UE to determine a power optimized strategy for establishing a stable connection to an NTN.

The UE can predict nearby infrastructure types that are likely to prohibit stable connection to an NTN due to an obstructed LOS to the NTN. For example, the disclosed system can use an internally stored geolocation map between the UE device and the surrounding environment to predict infrastructure types (e.g., buildings, highways, underground subways) that can obscure LOS. In response, the disclosed system can stop or pause the NTN mode, which stops attempts to scan for an NTN connection to reduce power consumption of the UE. Additionally, the disclosed system can monitor the environment surrounding the UE to determine changes in nearby infrastructure. Upon identifying a change in the environment that provides LOS to an NTN, the system can resume scanning for NTN services. Further, the UE can use a reference altitude data to infer whether the UE is within a building, on the roof, or in the underground subway to determine potential LOS obstructions to satellites.

While the NTN mode of the UE is paused, the UE can attempt to identify and access alternative network services. Examples of the alternative network services include a Wi-Fi network, a cellular network, or another UE device that has a connection to an alternative network service. The UE can use the alternative network services instead of scanning for an NTN coverage. If the UE fails to identify an available alternative network service after a threshold period, the UE can initiate a standard scan for NTN coverage for a specified duration. Upon failing to identify NTN coverage after the specified duration, the system can stop additional scan attempts to find NTN coverage until a change in the environment surrounding the UE device is detected.

In contrast, existing systems typically use a continuous scan strategy to search for an available NTN service connection in absence of a terrestrial network (TN) service, which can result in excess power consumption with no guarantee of NTN coverage. For example, existing systems initiate a scan at the UE device for an NTN service after losing connection with a TN and/or a cellular network service. However, when there is an environmental obstruction preventing direct LOS between the UE device and the NTN service, a stable connection to the NTN service cannot be made. In these situations, existing systems may continue to scan for available NTN services and thus rapidly drain the battery life of the UE device. As a result, these and other problems can significantly reduce battery life of UE devices, which can negatively impact telecommunication service providers, subscribers, third-party services, and so forth. Accordingly, there is a need for technologies that overcome the foregoing problems and provide additional benefits. For example, there is a need for a system that can identify invalid situations where a stable NTN connection is unavailable and subsequently stop future attempts to identify an available NTN. Additionally, there is a need for a system that can pursue alternative, and more efficient, methods for establishing an NTN connection to conserve battery life.

Advantages of the disclosed technology include improved ability to manage power consumption of UE devices when attempting to connect to NTNs, such as by identifying indirect connection routes to the NTN via nearby connected devices and/or alternative telecommunications services. Additionally, the disclosed technology can utilize a relational geolocation map to identify invalid infrastructure elements that can hinder connectivity with NTNs. As a result, the disclosed technology can intelligently determine an unlikelihood of connecting to an NTN and subsequently stop scanning for an NTN connection, resulting in reduced battery consumption. Furthermore, the disclosed technology can intelligently determine a reduction of invalid infrastructure elements in the surrounding environment and subsequently initiate a new scan for an NTN connection automatically.

For illustrative purposes, examples are described herein in the context of NTNs. However, a person skilled in the art will appreciate that the disclosed system can be applied in other contexts. For example, the disclosed system can be used to manage power consumption of UE devices when connecting to other telecommunication services, such as air-to-ground (ATG) networks, beyond an NTN.

The operation to pause periodic NTN scanning and/or scan for an alternative network, as disclosed herein, causes a reduction in greenhouse gas emissions compared to conventional methods of uninterrupted NTN scanning when the wireless device is in an NTN mode. Every year, approximately 40 billion tons of CO₂ are emitted around the world. Power consumption by digital technologies including telecommunications networks accounts for approximately 4% of this figure. Further, scanning for NTNs can exacerbate the causes of climate change. For example, the average U.S. power plant expends approximately 600 grams of carbon dioxide for every kWh generated. The implementations disclosed herein for stopping or pausing the periodic scanning for NTNs can mitigate climate change by reducing and/or preventing additional greenhouse gas emissions into the atmosphere. For example, scanning for local wireless networks as an alternative to scanning for NTNs, as described herein, reduces electrical power consumption. In particular, by reducing the use of NTN scanning, the disclosed systems provide increased battery efficiency compared to traditional methods.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

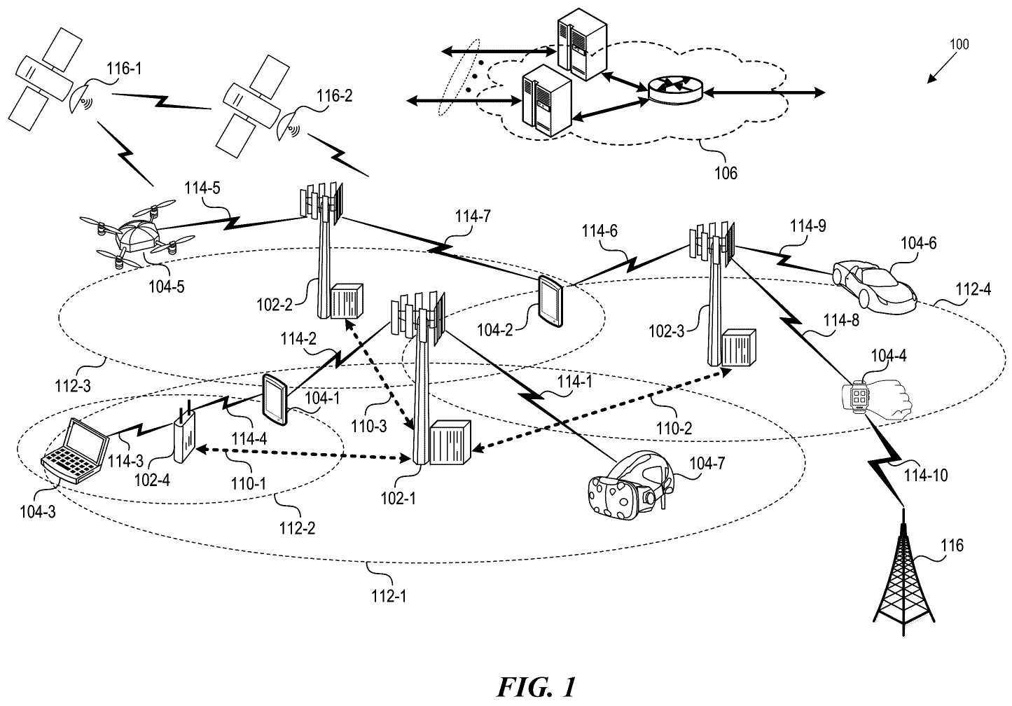

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, satellites 116 operating within the Earth's orbit, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage. In additional, or alternative embodiments, the network 100 can implement base stations 102 and NTN satellites 116 as cloud RAN and/or open RAN enabling cloud-native interfaces.

In some implementations of the network 100, the base stations 102 AND the NTN satellites 116 can be operated as cloud RAN and/or open RAN enabling cloud-native and open interface implementations

### Network Connection Environment

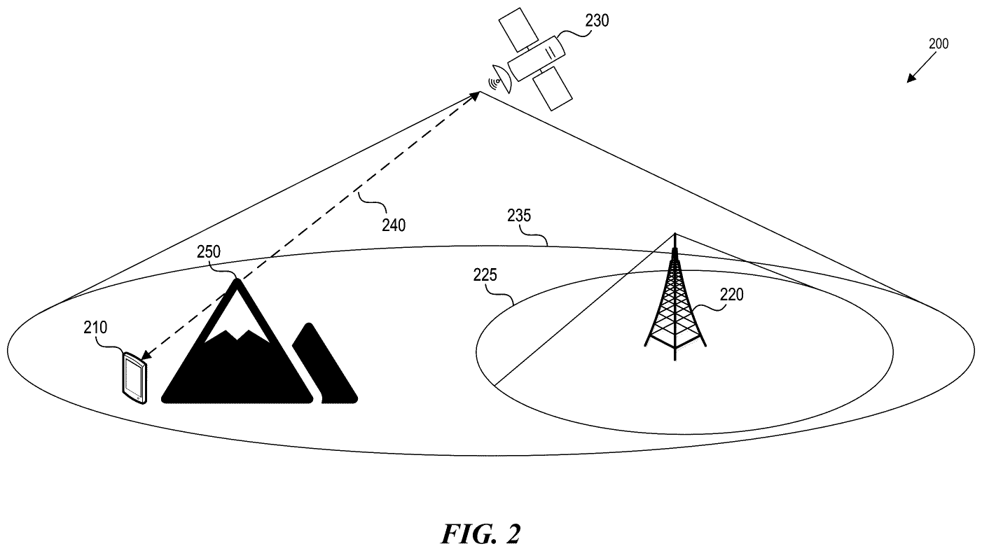

FIG. 2 is a block diagram that illustrates components of network connection environment 200 in some implementations. The environment 200 includes a wireless device 210, a local TN 220, an available NTN 230, and a physical obstruction 250, which are discussed in further detail below. All or portions of environment 200 can be provided, for example, by a telecommunications service that provides all or portions of the environment 200 using one or more components of the network 100.

To conserve power consumption in the process of searching for available network services, a wireless device 210 can employ systems and methods described herein to reduce excess scan operations. The systems and/or methods can be implemented with a combination of software (e.g., executable instructions or computer code) and hardware (e.g., one or more memories and one or more processors) of the wireless device 210. Accordingly, as used herein, in some examples, the wireless device 210 represents a computing device having one or more processors that are at least temporarily configured and/or programmed by executable instructions carried in one or more memories to perform one or more of the functions described herein.

In some embodiments, wireless device 210 can connect to a local TN 220 when the device 210 attempts to find a nearby network service. For example, wireless device 210 can establish a connection to the local TN 220 when the device is within a cellular coverage range 225 of the local TN. In other embodiments, wireless device 210 can attempt to connect to an available NTN 230 when the device 210 is outside of a cellular coverage range 225 of a local TN. As shown in FIG. 2, the device 210 can attempt to connect to an available NTN 230 when the device 210 is within a satellite coverage range 235 of the available NTN 230 and outside of the cellular coverage range 225 of the local TN.

In some embodiments, the wireless device 210 can enter an NTN mode for periodically scanning for available NTNs 230 (e.g., NTNs that cover the wireless device 210 within the satellite coverage range 235) to connect with. For example, the wireless device 210 will periodically scan for a visible LOS 240 from a current geolocation of the device 210 to the available NTN 230. The wireless device 210 can determine the current geolocation based on satellite navigation coordinate information, such as the Global Positioning System (GPS). In response to a successful detection of an available NTN 230 with an unobstructed LOS 240, the wireless device 210 can establish a network connection with the NTN 230.

In some embodiments, the wireless device 210 can determine that a physical obstruction 250 prevents a clear LOS 240 (e.g., an unobstructed line-of-sight) from the current geolocation of the device 210 to the available NTN 230. For example, the wireless device 210 can use the current geolocation of the device 210 and an internal map data stored on the device 210 to determine potential physical obstructions 250 that are preventing clear LOS 240 from the device 210 to the NTN 230. The internal map data stored on the wireless device 210 can include approximate geolocations corresponding to the potential physical obstructions 250. Further, the wireless device 210 can use the geolocation information from the internal map data to refine the current geolocation (e.g., generate a more precise estimate geolocation) of the device 210. In additional or alternative embodiments, the wireless device 210 can use an altitude sensor (e.g., embedded within the device 210 hardware) to determine a relative altitude of the device 210 with respect to one or more physical obstructions 250. Based on the determined relative altitude, the wireless device 210 can assess whether the LOS 240 between the device 210 and an available NTN 230 is obscured by the one or more physical obstructions 250. As depicted in FIG. 2, physical obstructions 250 between the wireless device 210 and available NTNs 230 can include dense natural landscapes (e.g., trees, forests, mountains, and/or the like) and/or infrastructure elements (e.g., enclosed buildings, underground passages, highway bridges, and/or similar structures of the like) that prevent clear LOS 240 from the wireless device 210 to an available NTN 230.

In some embodiments, the wireless device 210 can implement a modified scanning procedure for an available NTN 230 based on determining whether a physical obstruction 250 prevents a clear LOS 240 from the device 210 to the NTN 230. For example, the wireless device 210, in response to determining a physical obstruction 250, can deactivate the NTN mode to temporarily pause the periodic scan for an available NTN 230. As such, the wireless device 210 can conserve additional power (e.g., battery life) until the device 210 receives an indication of a possible clear LOS 240 with an available NTN 230. In additional or alternative embodiments, the wireless device 210 can estimate a new current geolocation of the device 210 at periodic intervals to identify changes in the immediate environment surrounding the device 210. Based on the new current geolocation, the wireless device 210 can perform another determination of whether a physical obstruction 250 blocks a clear LOS 240 from the device 210 to the NTN 230. In response to determining that a clear LOS 240 can be established with the NTN 230, the wireless device 210 can reactivate the NTN mode and resume a periodic scan for an available NTN 230.

In some embodiments, the wireless device 210 can periodically scan for alternative network connections in response to determining that a physical obstruction 250 prevents clear LOS 240 to an available NTN 230 (e.g., and temporarily pausing periodic scanning for NTN 230). For example, the wireless device 210 can identify a wireless local area network (e.g., a Wi-Fi network) as a stable alternative network and establish a connection with the wireless local area network. In other examples, the wireless device 210 can identify a device-to-device (D2D) side-link communication as a stable alternative network and establish a connection with the D2D side-link communication. In further embodiments, the wireless device 210 can reactivate the NTN mode and resume a periodic scan for an available NTN 230 upon a detected disconnection from the identified alternative network. In other embodiments, the wireless device 210 can enable a battery conservation mode (e.g., an embedded feature of the device 210) for periodically scanning for alternative network connections at a lower-than-usual scanning frequency to save power consumption and reduce greenhouse gas emissions.

In additional or alternative embodiments, the wireless device can resume a modified periodic scan for an available NTN 230 in response to a failed detection of an alternative network connection. For example, the wireless device 210 can determine an absence of alternative networks (e.g., wireless local area network, D2D communication) and subsequently resume periodic scanning for an available NTN 230 at a reduced scan frequency. As such, the wireless device 210 can continue to actively search for available NTN 230 connections while conserving battery power.

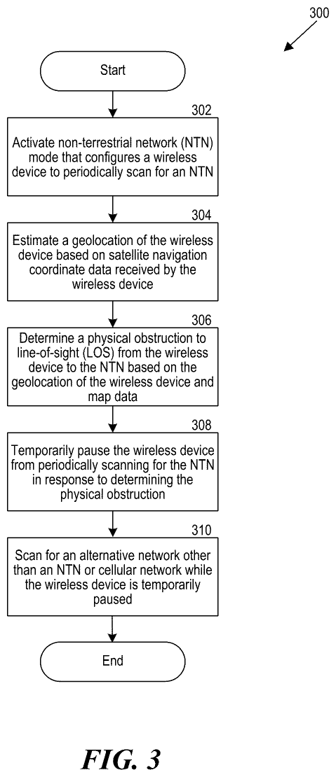

FIG. 3 is a flow diagram that illustrates a process to configure a wireless device in some implementations. The process 300 can be performed by a system (e.g., a wireless device) configured to conserve energy when scanning to connect to a non-terrestrial network (NTN). In one example, the wireless device includes at least one hardware processor and at least one non-transitory memory storing map data and instructions, which, when executed by the at least one hardware processor, cause the wireless device to perform the process 300. In another example, the wireless device includes a non-transitory, computer-readable storage medium comprising instructions recorded thereon, which, when executed by at least one data processor of the wireless device, cause the wireless device to perform the process 300.

At 302, the wireless device can activate an NTN mode that configures the wireless device to periodically scan for an NTN. For example, the wireless device can connect to the NTN by requiring a line-of-sight (LOS) from the wireless device to the NTN. In other embodiments, the wireless device can temporarily deactivate the NTN mode to pause the device from scanning for the NTN. For example, the wireless device can activate a battery conservation mode to scan for the alternative network such that activation of the battery conservation mode results in reduction of greenhouse gas emissions.

At 304, the wireless device can estimate a geolocation of the wireless device based on satellite navigation coordinate data received by the wireless device. For example, the wireless device can use Global Positioning System (GPS) coordinate data to estimate a current geolocation of the wireless device.

At 306, the wireless device can determine a physical obstruction to LOS from the wireless device to the NTN based on the geolocation of the wireless device and the map data. For example, the wireless device can use indications from the map data that correspond to geolocations with potential physical obstructions of LOS to the NTN to determine the physical obstruction. In some embodiments, the wireless device can include an altitude sensor, which can be used by the wireless device to detect an altitude of the wireless device relative to the physical obstruction, such that the physical obstruction is determined to obstruct the LOS based on the altitude of the wireless device.

At 308, the wireless device can temporarily pause the periodic scan for the NTN in response to the determination of the physical obstruction to LOS from the wireless device to the NTN. In some embodiments, the wireless device can estimate a new geolocation of the wireless device based on the map data stored in the non-transitory memory. For example, the wireless device can generate a new estimated geolocation (e.g., using satellite navigation coordinate data) sometime after pausing the periodic scan for the NTN. As such, the wireless device can determine an unobstructed LOS from the wireless device to the NTN based on the map data and the new geolocation of the wireless device. Additionally, the wireless device can resume the periodic scanning for the NTN in response to the determination of the unobstructed LOS from the wireless device to the NTN.

At 310, the wireless device can scan for an alternative network other than an NTN or cellular network while the wireless device is temporarily paused from periodically scanning for the NTN. For example, the wireless device can identify a wireless local area network (e.g., Wi-Fi connection) as the alternative network. As such, the wireless device can connect to the wireless local area network as an alternative network connection to the NTN. In some embodiments, the wireless device can commence rescanning for the NTN after losing connection for a threshold period to the wireless local area network. In additional or alternative embodiments, the wireless device can identify the alternative network through a device-to-device (D2D) connection. As such, the wireless device can connect to the alternative network through the D2D connection as an alternative network connection to the NTN. In some embodiments, the wireless device can commence rescanning for the NTN after losing connection for a threshold period to the alternative network.

In some embodiments, the wireless device can deactivate the NTN mode in response to establishing a connection with an alternative network. For example, the wireless device can deactivate the NTN mode to temporarily pause the device from periodically scanning for the NTN. In additional or alternative embodiments, the wireless device can reactivate the NTN mode to commence rescanning for the NTN after losing connection to the alternative network for a threshold period. In other embodiments, the wireless device can determine an absence of the alternative network (e.g., failure to establish connection with an available alternative network). In response to the determination of the absence of the alternative network, the wireless device can set a lower frequency for the periodicity that the device scans for the NTN and resume the periodic scanning by the device for the NTN at that frequency.

### Computer System

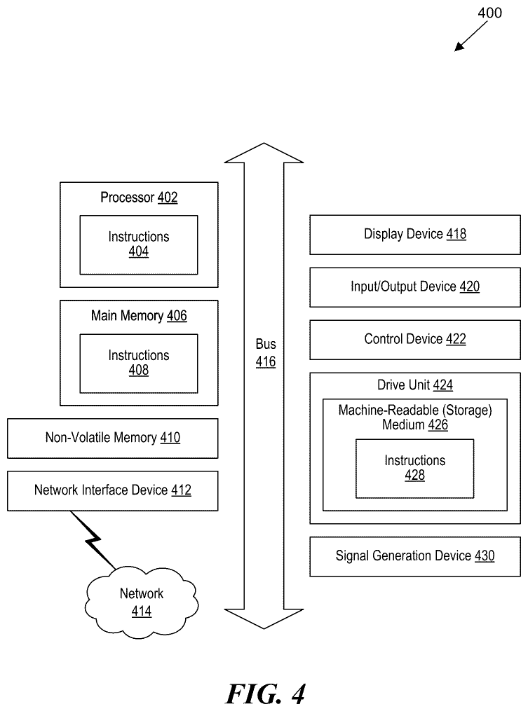

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, a video display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computer system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A wireless device configured to conserve energy when scanning to connect to a non-terrestrial network (NTN), the wireless device comprising:
at least one hardware processor; and
at least one non-transitory memory storing map data and instructions, which, when executed by the at least one hardware processor, cause the wireless device to:
activate an NTN mode that configures the wireless device to periodically scan for an NTN,
wherein connecting to the NTN requires line-of-sight (LOS) from the wireless device to the NTN;
estimate a geolocation of the wireless device based on Global Positioning System (GPS) coordinate data received by the wireless device;
determine a physical obstruction to LOS from the wireless device to the NTN based on the geolocation of the wireless device and the map data,
wherein the map data includes indications of geolocations with potential physical obstructions of LOS to the NTN;
in response to the determination of the physical obstruction to LOS from the wireless device to the NTN, temporarily pause the wireless device from periodically scanning for the NTN; and
while the wireless device is temporarily paused from periodically scanning for the NTN, cause the wireless device to scan for an alternative network other than an NTN or cellular network.

2. The wireless device of claim 1 further caused to:
estimate a new geolocation of the wireless device based on the map data stored in the non-transitory memory;
determine an unobstructed LOS from the wireless device to the NTN based on the new geolocation of the wireless device and the map data; and
in response to the determination of the unobstructed LOS from the wireless device to the NTN, resume the periodic scanning by the wireless device for the NTN.

3. The wireless device of claim 1 further comprising:
an altitude sensor,
wherein the wireless device is further caused to:
detect, using the altitude sensor, an altitude of the wireless device relative to the physical obstruction,
wherein the physical obstruction is determined to obstruct the LOS based on the altitude of the wireless device.

4. The wireless device of claim 1 further caused to:
determine an absence of the alternative network; and
in response to the determination of the absence of the alternative network, set a lower frequency for the periodicity that the wireless device scans for the NTN and resume the periodic scanning by the wireless device for the NTN at that frequency.

5. The wireless device of claim 1 further caused to:
identify a wireless local area network as the alternative network;
connect the wireless device to the wireless local area network; and
cause the wireless device to commence rescanning for the NTN after losing connection for a threshold period to the wireless local area network.

6. The wireless device of claim 1 further caused to:
identify the alternative network through a device-to-device (D2D) connection;
connect the wireless device to the alternative network through the D2D connection; and
cause the wireless device to commence rescanning for the NTN after losing connection for a threshold period to the alternative network.

7. The wireless device of claim 1 further caused to:
temporarily deactivate the NTN mode to pause the wireless device from scanning for the NTN; and
activate a battery conservation mode to scan for the alternative network,
wherein activation of the battery conservation mode results in reduction of greenhouse gas emissions.

8. The wireless device of claim 1 further caused to:
deactivate the NTN mode to temporarily pause the wireless device from periodically scanning for the NTN; and
reactivate the NTN mode to commence rescanning for the NTN after losing connection for a threshold period to the alternative network.

9. A non-transitory, computer-readable storage medium comprising instructions recorded thereon, wherein the instructions, when executed by at least one data processor of a wireless device, cause the wireless device to:
activate the wireless device to periodically scan for an unobstructed line-of-sight (LOS) from the wireless device to an NTN;
estimate a geolocation of the wireless device based on satellite navigation coordinate data received by the wireless device;
determine a physical obstruction to LOS from the wireless device to the NTN based on the geolocation of the wireless device and a map data,
wherein the map data includes indications of geolocations with potential physical obstructions of LOS to the NTN;
in response to the determination of the physical obstruction to LOS from the wireless device to the NTN, temporarily pause the wireless device from periodically scanning for the NTN; and
while the wireless device is temporarily paused from periodically scanning for the NTN, cause the wireless device to scan for an alternative network other than an NTN or cellular network.

10. The non-transitory, computer-readable storage medium of claim 9, wherein the instructions further cause the wireless device to:
estimate a new geolocation of the wireless device based on the map data;
determine an unobstructed LOS from the wireless device to the NTN based on the new geolocation of the wireless device and the map data; and
in response to the determination of the unobstructed LOS from the wireless device to the NTN, resume the periodic scanning by the wireless device for the NTN.

11. The non-transitory, computer-readable storage medium of claim 9, wherein the instructions further cause the wireless device to:
determine an absence of the alternative network; and
in response to the determination of the absence of the alternative network, set a lower frequency for the periodicity that the wireless device scans for the NTN and resume the periodic scanning by the wireless device for the NTN at that frequency.

12. The non-transitory, computer-readable storage medium of claim 9, wherein the instructions further cause the wireless device to:
identify a wireless local area network as the alternative network;
connect the wireless device to the wireless local area network; and
cause the wireless device to commence rescanning for the NTN after losing connection for a threshold period to the wireless local area network.

13. The non-transitory, computer-readable storage medium of claim 9, wherein the instructions further cause the wireless device to:
identify the alternative network through a device-to-device (D2D) connection;
connect the wireless device to the alternative network through the D2D connection; and
cause the wireless device to commence rescanning for the NTN after losing connection for a threshold period to the alternative network.

14. The non-transitory, computer-readable storage medium of claim 9, wherein the instructions further cause the wireless device to:
temporarily pause the wireless device from scanning for the NTN; and
activate a battery conservation mode to scan for the alternative network,
wherein activation of the battery conservation mode results in reduction of greenhouse gas emissions.

15. The non-transitory, computer-readable storage medium of claim 9, wherein the instructions further cause the wireless device to:
temporarily pause the wireless device from periodically scanning for the NTN; and
resume the periodic scanning by the wireless device for the NTN after losing connection for a threshold period to the alternative network.

16. A method performed by a wireless device to conserve energy when scanning to connect to a non-terrestrial network (NTN), the method comprising:
activating the wireless device to periodically scan for a line-of-sight (LOS) from the wireless device to an NTN;
estimating a geolocation of the wireless device based on satellite navigation coordinate data received by the wireless device;
determining a physical obstruction to LOS from the wireless device to the NTN based on the geolocation of the wireless device and a map data,
wherein the map data includes geolocations of potential physical obstructions for LOS to the NTN;
in response to determining the physical obstruction to LOS from the wireless device to the NTN, temporarily pausing the wireless device from periodically scanning for the NTN; and
while the wireless device is temporarily paused from periodically scanning for the NTN, causing the wireless device to scan for an alternative network other than an NTN or cellular network.

17. The method performed by the wireless device of claim 16, the method further comprising:
estimating a new geolocation of the wireless device based on the map data;
determining an unobstructed LOS from the wireless device to the NTN based on the new geolocation of the wireless device and the map data; and
in response to the determination of the unobstructed LOS from the wireless device to the NTN, resuming the periodic scanning by the wireless device for the NTN.

18. The method performed by the wireless device of claim 16, the method further comprising:
determining an absence of the alternative network; and
in response to the determination of the absence of the alternative network, setting a lower frequency for the periodicity that the wireless device scans for the NTN and resuming the periodic scanning by the wireless device for the NTN at that frequency.

19. The method performed by the wireless device of claim 16, the method further comprising:
identifying a wireless local area network as the alternative network;
connecting the wireless device to the wireless local area network; and
causing the wireless device to commence rescanning for the NTN after losing connection for a threshold period to the wireless local area network.

20. The method performed by the wireless device of claim 16, the method further comprising:
identifying the alternative network through a device-to-device (D2D) connection;
connecting the wireless device to the alternative network through the D2D connection; and
causing the wireless device to commence rescanning for the NTN after losing connection for a threshold period to the alternative network.
